(19) United States
(12) Patent Application Publication
(10) Pub. No.: US 2017/0337585 A1
(43) Pub. Date: Nov. 23, 2017

(54) Systems and Methods for Providing Advertising Content to Advertising Media

(71) Applicant: MASTERCARD INTERNATIONAL INCORPORATED, Purchase, NY (US)

(72) Inventors: Mark N. Savoye, Hartsdale, NY (US); Travis M. Carpenter, Glencoe, MO (US); Kyle P. Clark, High Ridge, MO (US)

(21) Appl. No.: 15/156,700

(22) Filed: May 17, 2016

(51) Int. Cl. G06Q 30/02; H04W 4/12

(52) U.S. Cl. CPC G06Q 30/0267; H04W 4/12; G06Q 30/0261; G06Q 30/0269

(57) ABSTRACT

Systems and methods are provided for directing advertising content to advertising media specific to one or more consumers proximate the advertising media. An example method includes receiving, by a computing device, a media proximity message (MPM) associated with an advertising medium. The method also includes accessing, by the computing device, location context for the advertising medium from an advertising media data structure, based on an advertising medium identifier in the MPM, and accessing a consumer profile for the consumer, based on a consumer identifier in the MPM, from a consumer profiles data structure. The method further includes selecting, by the computing device, an advertising content, from an advertising content data structure, based on at least the consumer profile and the location context, and causing the selected advertising content to be displayed at the advertising medium.

### FIELD

The present disclosure generally relates to systems and methods for providing, to advertising media, advertising content that is particularly associated with (e.g., specific to, or personal to, etc.) consumers proximate to (or in the general vicinity of) the advertising media.

### BACKGROUND

This section provides background information related to the present disclosure which is not necessarily prior art.

Payment accounts are used by consumers to perform numerous different transactions including, for example, purchasing products (e.g., goods and/or services) from merchants, etc. Transaction data is often generated in connection with the purchase transactions. The transaction data can then be processed to provide insight into purchasing behavior of the consumers. As such, a consumer's purchase history can be used in identifying advertisements for that consumer, via a variety of mechanisms, including website advertising popups, emails, paper mailings, etc. Separately, dynamic advertising spaces are known. These advertising spaces include display devices, such as LED billboards, which may be changed periodically to thereby multiply a number of products that can be advertised thereon. Not only can different products be advertised, but the particular content of the advertisements, per product, can be changed.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in providing advertising content to advertising media specific to one or more consumers in the general vicinity of the advertising media;

FIG. 2 is a block diagram of an exemplary computing device that may be used in the system of FIG. 1;

FIG. 3 is an exemplary method, which can be implemented via the system of FIG. 1, for providing the advertising content to the advertising media; and

FIGS. 4 and 5 are exemplary interfaces that may be generated and displayed at advertising media in connection with the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transaction data is often compiled by payment networks, for example, in connection with payment device transactions by consumers at merchants. The transaction data may then be used, by the payment networks, to indicate the potential of the consumers to make certain kinds of purchases (e.g., as propensity scores, etc.). The systems and methods herein identify consumers to particular advertising media, and/or vice-versa, and then direct consumer-specific advertising to the advertising media based on the identified consumers. In particular, when a consumer is identified as being in proximity to an advertising medium, embodiments of the systems and methods described herein may identify, based on a location context of the advertising medium and/or a profile of the consumer (e.g., including transaction data for the consumer, etc.), advertising content for display on the advertising medium to the consumer corresponding with likely purchases by the consumer (e.g., advertising content that is specific to, or personal to, the consumer, etc.).

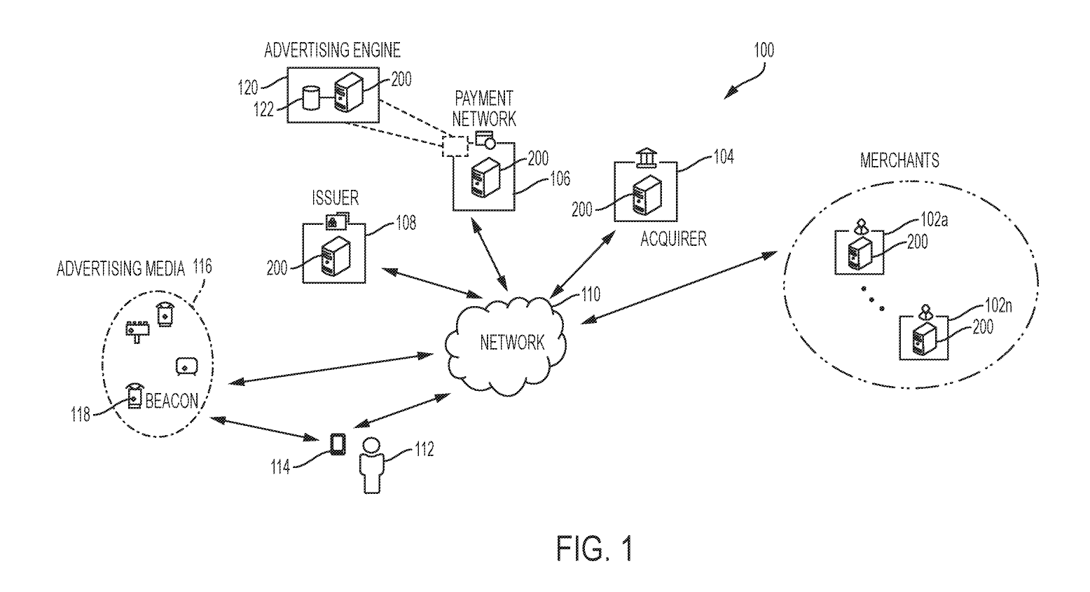

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, processing of payment transactions, delivery of advertising content, etc.

As shown in FIG. 1, the illustrated system 100 generally includes multiple merchants 102a-n, an acquirer 104, a payment network 106, and an issuer 108, each coupled to (and in communication with) a network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In particular in this example, the acquirer 104, the payment network 106, and the issuer 108 may be connected via a private payment network that is part of network 110 for processing payment transactions, and the merchants 102a-n may be connected with consumers (e.g., a consumer 112, etc.), for example, through a public network, such as the Internet, that is also part of network 110.

In this exemplary embodiment, the merchants 102a-n represent multiple different merchants, each providing one or multiple products for sale. To facilitate the sale of products, the merchant 102a-n may provide offers, coupons, sales, etc., by which consumers (e.g., consumer 112, etc.), may purchase products at a discount, or otherwise by favorable terms. It should be appreciated that while only exemplary merchants 102a-n offering products are provided herein, for purposes of illustration, the system 100 may include any different number and/or type of merchant offering any other products.

In the system 100, the consumer 112 is associated with a communication device 114, such as a portable communication device (e.g., a smartphone, a cellular phone, a tablet, etc.). Typically, the communication device 114 includes one or more applications, which enable the communication device 114 to perform as described herein. Further, the consumer 112 is associated with a payment account, provided by the issuer 108. The payment account is linked to a payment device, such as, for example, a payment card, a payment token, a payment tag, a pass, and/or a communication device (e.g., the communication device 114, etc.) configured by an electronic wallet (or e-wallet) application, etc. To initiate a transaction, funded by the payment account, the consumer 112 presents the payment device to a merchant, such as, for example, the merchant 102a.

In an exemplary transaction, the consumer 112 may present the payment device to the merchant 102a in connection with purchasing products from the merchant 102a. In turn, the merchant 102a reads the payment device, for example, at a POS terminal, and communicates an account number for the payment account associated with the payment device and an amount of the purchase to the acquirer 104, for example, through the network 110, to determine if the consumer's payment account is in good standing and if there is/are sufficient credit/funds to complete the transaction (i.e., as an authorization request). The acquirer 104, in turn, communicates with the issuer 108, through the payment network 106, again via the network 110, for authorization of the transaction. If the issuer 108 accepts the transaction, an authorization reply is provided back to the merchant 102a and the merchant 102a completes the transaction. The credit line or funds of the consumer 112, depending on the type of payment account, is then decreased by the amount of the purchase, and the charge is posted to the account associated with the payment device. The transaction is later cleared and settled by and between the merchant 102a and the acquirer 104 and by and between the acquirer 104 and the issuer 108 (in accordance with settlement arrangements, etc.). Conversely, if the issuer 108 declines the transaction, an authorization reply is provided back to the merchant 102a and the merchant 102a is able to terminate the transaction with the consumer 112, or request an alternate form of funding.

Transaction data is generated, collected, and stored as part of the above interactions among the merchant 102a (and for similar transactions involving other merchants), the acquirer 104, the payment network 106, the issuer 108, and the consumer 112. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the acquirer 104 and/or the issuer 108 may store the transaction data, or part thereof, in a data structure. The transaction data may be stored in any desired manner in the system 100.

Transaction data may include, for example, payment account numbers, amounts of transactions, merchant IDs, merchant category codes (MCCs), region codes (or other location identifiers) for merchants involved in transactions (or POS terminals associated with the merchants), DBA names, dates/times of transactions, products purchased and related descriptions or identifiers, etc. It should be appreciated that more or less information related to transactions, as part of either authorization and/or clearing and/or settling, may be included in transaction data and stored within the system 100, at the merchants 102a-n, the acquirer 104, the payment network 106, and/or the issuer 108. Further, transaction data, unrelated to a particular payment account, may be collected by a variety of techniques, and similarly stored within the system 100.

In various exemplary embodiments, consumers (e.g., consumer 112, etc.) and merchants (e.g., merchants 102a-n, etc.) involved in the different transactions herein are prompted to agree to legal terms associated with their payment accounts, for example, during enrollment in their accounts, etc. In so doing, the consumers and merchants may voluntarily agree, for example, to allow issuers of the payment accounts, payment networks, etc., to use data collected during enrollment and/or collected in connection with processing the transactions, subsequently for one or more of the different purposes described herein.

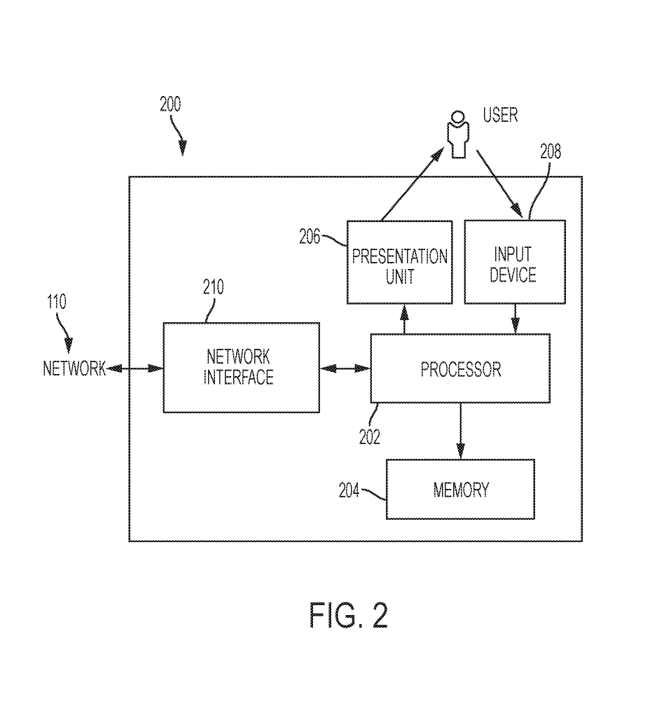

FIG. 2 illustrates an exemplary computing device 200 that can be used in the system 100. The computing device 200 may include, for example, one or more servers, workstations, personal computers, laptops, tablets, smartphones, POS terminals, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the merchants 102a-n, the acquirer 104, the payment network 106, and the issuer 108 are illustrated as including, or being implemented in, computing device 200, coupled to the network 110. Likewise, the communication device 114 associated with the consumer 112 is a computing device consistent with the computing device 200. However, the system 100 should not be considered to be limited to the computing device 200, as described below, as different computing devices and/or arrangements of computing devices may be used.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data, advertising content, advertising media identifiers (IDs), and/or other types of data and/or information suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to (and is in communication with) the processor 202 (however, it should be appreciated that the computing device 200 could include output devices other than the presentation unit 206, etc.). The presentation unit 206 outputs information, either visually or audibly to a user of the computing device 200, for example, consumer 112 or an analyst user associated with the payment network 106 in the system 100, individuals associated with other parts of the system 100, etc. It should be further appreciated that various interfaces (e.g., advertising content, etc.) may be displayed at computing device 200, and in particular at presentation unit 206, to display information, such as, for example, advertising to consumers, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 further includes an input device 208 that receives inputs from the user of the computing device 200 (i.e., user inputs) such as, for example, coupon or discount codes, customer information, advertisement information, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit 206 and an input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 also includes multiple advertising media 116. As illustrated, the advertising media 116 may include a variety of different types of media, including, for example, dynamic signage (e.g., billboards, kiosks, terminals, etc.) and any other media in which advertising content may be displayed and/or changed, etc. The advertising content may include visual and/or audio aspects. Regardless of the particular type, the advertising media 116 are configured to display or otherwise present advertising content, for example, to the consumer 112 (and to others). The advertising media 116 are disposed in positions within a region or region(s) whereby a consumer traveling on foot or by vehicle would be able to view or otherwise observe the media 116. For example, advertising media 116 may be presented in shopping malls, or in urban shopping districts along the side of benches of bus stops, in kiosks, on buildings, as well as along walkways, roads, highways, intersections, etc. In general, the advertising media 116 is located proximate to or in the vicinity of the merchants 102a-n, or other merchants, and often in locations in which consumers (e.g., consumer 112, etc.) are present and/or travelling, etc. Regardless of the particular locations of the advertising media 116, they are dynamic, such that the advertising media 116 may present one advertising content at one time, and a different advertising content at another time (i.e., without manual intervention). As such, the advertising media 116 may be considered computing devices, each generally consistent with computing device 200.

Each of the advertising media 116 is associated with a beacon 118, which is configured to emanate a unique (or substantially unique) beacon identifier (or ID) associated with the advertising media 116. The beacon 118, in certain embodiments, is consistent with computing device 200 and may wireles sly broadcast or otherwise emanate the beacon ID for the advertising media 116, for example, as a Bluetooth® signal, other suitable signal, etc. In one example, the beacon 118 includes an iBeacon® device. However, it should be appreciated that any suitable device or technology may be used in connection with the beacon 118 including, for example, a Bluetooth® beacon, etc. In this exemplary embodiment, the communication device 114 is configured, by an appropriate application, to detect the beacon ID from the beacon 118, when in close proximity to the advertising media 116, and further to communicate the beacon ID (as well as a consumer ID for the consumer 112) to an advertising engine 120, described below. Additionally, or alternatively, the communication device 114 may be configured, by an appropriate application, to emanate or otherwise broadcast a unique consumer ID (i.e., unique to the consumer 112, the communication device 114, and/or payment account, etc.), for example, as a Bluetooth® signal, other suitable signal, etc., which is then detected and/or otherwise received by the beacon 118 when the communication device 114 is in close proximity to the advertising media 116. In such an embodiment, the beacon 118 is configured to, in turn, communicate the consumer ID (as well as the advertising medium ID) to the advertising engine 120. In this manner, the advertising medium 116 and the consumer 112 are capable of directly interacting. In other embodiments, the advertising medium 116 and the consumer's communication device 114 may interact via the network 110, etc.

The advertising engine 120 of the system 100 is included in, or is implemented in, a computing device consistent with computing device 200. In connection therewith, the advertising engine 120 is configured, by computer-executable instructions, to perform as described herein. The advertising engine 120 is also illustrated as a separate and standalone part of the system 100. However, the advertising engine 120 may be incorporated in the payment network 106 in various embodiments, as indicated by the dotted lines in FIG. 1. In other embodiments, the advertising engine 120 may be incorporated, at least in part, in other parts of the system 100, for example, the issuer 108, one or more of the merchants 102a-n, etc. Regardless of its particular location and/or integration, the advertising engine 120, in this embodiment, is in communication with the payment network 106, for example, via network 110, to allow access to transaction data stored therein. Additionally, or alternatively, the advertising engine 120 may communicate with one or more other parts of system 100 (e.g., the issuer 108, etc.) to access transaction data therefrom.

The advertising engine 120 is also in communication with the advertising media 116 in the system 100, via network 110, to communicate therewith. In particular, the advertising engine 120 is configured to direct, via the network 110, advertising content to the advertising media 116 (i.e., cause advertising content to be displayed thereon, etc.), as described herein.

With continued reference to FIG. 1, the system 100 further includes a data structure 122 associated with the advertising engine 120. As will be described, the data structure is segregated into three structures: an advertising content structure, an advertising media structure, and a consumer profiles structure. Various data associated with the system 100 is stored in the data structure in one (or more) of the different structures.

The advertising content portion of the data structure 122, for example, includes advertising content from the merchants 102a-n (and/or other merchants). The advertising content may include images and/or scripts showing the pricing for certain products, and/or may include offers, coupons, discounts, rebates, etc., offered by the merchants 102a-n (and/or other merchants) for certain products, multiple products, and/or product independent. In general, each of the merchants 102a-n, at one or more regular or irregular intervals, provides advertising content to the advertising engine 120, which stores the advertising content in the data structure 122. Alternatively, or additionally, the advertising engine 120 may pull advertising content from the merchants 102a-n, as appropriate, and store the content in the data structure 122. The advertising content may include particular images of products, product descriptions, product categories and/or MCCs, barcodes relating to the products, QR codes relating to the products, etc.

The advertising media portion of the data structure 122 includes data associated with each advertising media 116, Such data may include, for example, locations of the advertising media 116 (e.g., latitude/longitude location data, etc.), the beacon ID for each of the advertising media 116, a resolution and/or size of each of the advertising media 116, etc.

The consumer profiles portion of the data structure 122 includes consumer profiles, for example, for the consumer 112 and for other consumers (not shown). In this exemplary embodiment, the consumer 112, when installing the advertising application to the communication device 114, registers to the advertising engine 120 by providing certain consumer information, which is stored in the data structure 122. In addition, the advertising engine 120 may access transaction data for the consumer 112 from the payment network 106 and store such data (and/or various models for the consumer 112 associated with the transaction data) in the data structure 122. In so doing, the advertising engine 120 creates a consumer profile for the consumer 112, also at the data structure 122. The consumer information may include demographic information (e.g., age, gender, income, education, etc.) for the consumer 112, payment account information, contact information, the transaction histories for the consumer 112, the purchase propensity scores (or other models) for the consumer 112, etc. In addition, as part of the registration, the consumer 112 typically provides permission for the advertising application to interact with the beacon 118 for various ones of the advertising media 116 and/or to provide location information to the advertising engine 120 from the consumer's communication device 114, and further provides permission for the advertising engine 120 to access transaction data for one or more payment accounts associated with the consumer 112, etc.

In connection with the transaction data for the consumer 112 included in the consumer profile in the data structure 112, the transaction data may represent various transactions performed by the consumer 112 at various ones of the merchants 102a-n (e.g., in the form of a transaction history for the consumer 112, etc.), and/or it may represent one or more spending propensity models for the consumer 112. In connection with such spending propensity models, the transaction data may represent various purchase propensity scores (or other consumer segmentation propensity models) for the consumer 112. Such scores may be generated by the payment network 106, and transmitted to the advertising engine 120 when generating the consumer profile for the consumer 112. Or, such scores may be generated by the advertising engine 120, or elsewhere, based on transaction data for the consumer 112 accessed by the advertising engine 120, for example, from the payment network 106, when generating the consume profile. In either case, the scores may include any desired scores such as, for example, and without limitation, upscale dining propensity scores, quick service dining propensity scores, luxury shopping propensity scores, leisure travel propensity scores, etc. What's more, the scores may be generated in various different manners (e.g., using various different algorithms, etc.) based on, for example, the transaction history for the consumer 112 and/or the corresponding transaction data.

The advertising application installed to the consumer's communication device 114, for example, at registration, may be available to the consumer 112 in a downloadable form. For example, the application may be available from (for download), or may be associated with, the advertising engine 120, and may be specifically stored in non-transitory computer readable storage media on the communication device 114. As such, in connection with registering to the advertising engine 120, the consumer 112 downloads and installs the application to the communication device 114 and makes the application active, so that the communication device 114 can then execute corresponding computer-executable instructions, as described herein.

In general, in operation in the system 100, upon registration of the consumer 112 to the advertising engine 120, when the consumer 112 (and the consumer's communication device 114) are in close proximity to one of the advertising media 116, a message is transmitted from the advertising media 116 and/or the communication device 114 to the advertising engine 120. The advertising engine 120 then determines advertising content to be displayed at the particular one of the advertising media 116 proximate the location of the consumer 112, particularly for the consumer 112.

In particular, the advertising engine 120 is initially configured to receive a media proximity message (MPM) from one (or more) of the advertising media 116 and/or the communication device 114. The advertising engine 120 is then configured to identify the particular advertising medium 116 (relating to the MPM), and determine whether additional MPM's have been received for the advertising medium 116 (e.g., based on a proximity of other registered consumers to the advertising medium 116, etc.). If only one MPM is received (based on only the consumer 112 being proximate the advertising medium 116), the advertising engine 120 is configured to further access the data structure 122, and various information therein, and to determine which advertising content is to be displayed at the advertising media 116, based on at least a profile associated with the consumer 112. However, if additional MPM' s are received (based on other registered consumers being proximate the advertising medium 116), the advertising engine 120 is configured to generate an aggregate profile for the multiple MPM' s (i.e., aggregate to the multiple consumers proximate the advertising medium 116) and then to determine, based on at least the aggregate profile, which advertising content is to be displayed at the advertising media 116. Once the advertising content is determined, the advertising engine 120 is configured to cause the advertising content to be displayed at the advertising medium 116. In this manner, the advertising content at the advertising medium 116 may be specific and/or tailored to the consumer 112 and/or all other registered consumers in proximity to the advertising medium 116.

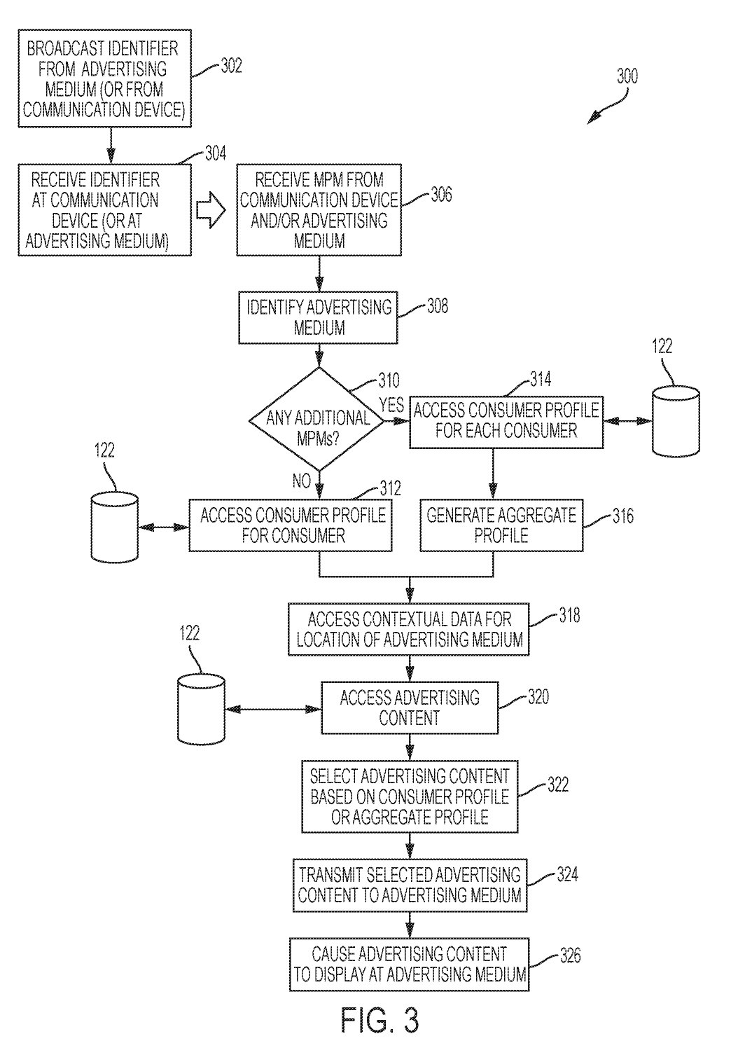

FIG. 3 illustrates an exemplary method 300 for providing advertising content to advertising media, where the advertising content is specific to consumers proximate to the advertising media. The exemplary method 300 is described as implemented in the system 100 and, more particularly, in the advertising engine 120 thereof. Further, for purposes of illustration, the exemplary method 300 is described herein with reference to other parts of the system 100 and the computing device 200. As should be understood, however, the methods herein are not limited to the exemplary system 100 or the exemplary computing device 200 and, similarly, the systems and the computing devices herein are not limited to the exemplary method 300.

With reference to FIG. 3, when a consumer, such as consumer 112, is in a shopping mall or other location, which includes advertising media 116, the consumer 112 may pass in close proximity to one of the advertising media 116 (e.g., about 2 ft., about 4 ft., about 8 ft., or more or less, etc.). When the consumer 112 is within proximity of a particular one of the advertising media 116, the communication device 114 associated with the consumer 112 and the beacon 118 associated with the particular advertising medium 116 interact. In particular in the method 300, the beacon 118 broadcasts, at 302, an identifier (broadly, a signal) specific to the advertising medium 116. In turn, the communication device 114, based on its proximity to the advertising medium (and the beacon 118), receives the advertising medium identifier, at 304. Alternatively, the communication device 114 may broadcast an identifier (broadly, a signal) specific to the consumer 112, the communication device 114 and/or the payment account of the consumer 112, etc. (e.g., at 302 in the method, etc.). And then, in turn, the beacon 118 (and the advertising medium 116) may receive the consumer identifier (e.g., at 304 in the method 300, etc.).

Next in the method 300, the communication device 114 (or, alternatively, the advertising medium 116) transmits a media proximity message (MPM), including the advertising medium identifier and the consumer identifier, to the advertising engine 120. Along with the advertising medium identifier (and the consumer identifier, the MPM may include additional data relating to the particular communication device 114 and/or the advertising medium 116 such as, for example, location data for the communication device 114 and/or the advertising medium 116, vector data representing movement of the consumer 112, etc. With that said, it should be appreciated that the MPM may include any information available to the communication device 114 and/or the advertising media 116, and that is potentially useful to the advertising engine 120 in performing the various operations herein.

In turn, the advertising engine 120 receives the MPM from the communication device 114 (or, alternatively, from the advertising medium 116), at 306, and identifies, at 308, in the data structure 122, the particular advertising medium 116 associated with the advertising medium identifier and/or the consumer 112 associated with the consumer identifier, as included in the MPM.

Then, the advertising engine 120 determines, at 310, whether any additional MPM's have been received for the identified advertising medium 116 (and, thus, whether aggregate advertising content should be provided to the advertising medium 116 to account for multiple different consumers). The determination, by the advertising engine 120, may be based on one or more predefined intervals, such as, for example, 1 minute, 2 minutes, 5 minutes, 15 minutes, etc. Often, the predefined interval will be sufficiently short (e.g., less than about 5 minutes, etc.) to facilitate prompt responses by the advertising engine 120. In addition, the determination may involve a sliding interval, with a configurable refresh rate provided, for example, at a display of the advertising medium 116. Here, multiple actions may then be taken into consideration by the advertising engine 120 over the sliding interval, with the display of the advertising medium 116 refreshing (or being configured to refresh (e.g., the sliding interval being reset to zero via a refresh interrupter, etc.)) every X seconds (or every X minutes), or potentially sooner, when there is interaction with the display (e.g., refreshed each time the display is touched by a consumer, refreshed each time a new MPM is received (indicating presence of a new consumer in the vicinity of the advertising medium 116), etc.). However, this is not required for all permutations of the methods herein.

As an example, the advertising medium 116 may include a configurable refresh rate of five minutes. As such, initially in this example, when the application on the consumer's communication device 114 identifies (or registers) that the beacon 118 associated with the advertising medium 116 is nearby, the application transmits an MPM to the advertising engine 120. The advertising engine 120 then determines if the configurable refresh period for the advertising medium 116 (i.e., the five minute period) has elapsed since the last advertising content change, and if so, the advertising engine 120 transmits new advertising content to the advertising medium 116 based on the recently received MPM (otherwise the advertising engine 120 waits for the refresh period to end and then transmits new advertising content). The advertising medium 116 then displays the new advertising content (unless, for example, a consumer is currently interacting with the display of the advertising medium 116 (in the event of interactive advertising)).

With continued reference to FIG. 3, when the advertising engine 120 determines, at 310, that no additional MPM's have been received, it accesses, at 312, the consumer profile for the consumer 112, from the data structure 122, based on the consumer identifier included in the MPM. As previously described, the consumer profile for the consumer 112 may include a variety of information related to the consumer 112, including, without limitation, name, residency, contact information, spending history over recent and/or other time periods, spending profiles, etc. In addition, the spending profiles for the consumer 112, included in the consumer profile, may include one or more scores, generated by the payment network 106, or elsewhere, including, for example, an upscale dining propensity score, a quick service dining propensity score, a luxury shopping propensity score, a leisure travel propensity score, etc. It should again be understood that the scores listed herein are merely exemplary in nature and that other different scores (or other consumer segmentation propensity models) may be included in the spending profile for the consumer 112. What's more, and as previously stated, the scores may be generated in various different manners (e.g., using different algorithms, etc.) based on, for example, transaction histories for the consumer 112, transaction data for the consumer 112, etc.

Alternatively, when the advertising engine 120 determines that additional MPM's have been received, at 310, the advertising engine 120 accesses, at 314, consumer profiles from the data structure 122 for consumers associated with each of the received MPM's (e.g., for each registered consumer in the vicinity of the advertising medium 116, etc.). Then, the advertising engine 120 generates, at 316, an aggregate profile based on the accessed consumer profiles. The aggregate profile may be based on any desired factors or features including, for example, features common to each of the accessed consumer profiles (i.e., common to each of the identified consumers in the vicinity of the advertising medium 116), features common to transaction data for each of the identified consumers, etc. For example, if the consumer profile for each of the identified consumers indicates a propensity for travel, the aggregate profile may similarly include such a propensity.

In either case in the method 300, the advertising engine 120 next accesses, at 318, contextual data for (or associated with) the location of the advertising medium 116. The contextual data may include, for example, time of day, day of week, weather for the location of the advertising medium 116, news, stock market data (e.g., stock pricing for certain merchants 102a-n, etc.), social media traffic (e.g., trending topics, etc.), current events, etc. The contextual data may be included in the MPM received by the advertising engine 120, or it may be accessed from a profile of the particular advertising medium 116 stored in the data structure 122. In addition, or alternatively, the advertising engine 120 may access the contextual data for the particular advertising medium 116 by searching at one or more third parties, based on the location (e.g., at news providers, etc.).

Further in the method 300, the advertising engine 120 accesses, at 320, advertising content available, at the data structure 122, for use at the advertising medium 116. The advertising content may be all advertising content available in the data structure 122, or it may include a subset of the advertising content based on one or more limitations. For example, the merchant 102a in the system 100 may have an agreement with the advertising engine 120 to only provide its advertising content at certain ones of the advertising media 116. Further, the use of the advertising content of certain ones of the merchants 102a-n may be limited by fees paid and/or locations of the particular merchants, etc.

After accessing the available advertising content, the advertising engine 120 selects particular advertising content therefrom, at 322, based (at the least) on either the consumer profile for the consumer 112 (when the advertising engine 120 receives an MPM from only the consumer 121) or the aggregate profile (when the advertising engine 120 receives MPM's from multiple consumers), and on the contextual data for the location of the advertising medium 116. For example, the consumer profile for the consumer 112 may indicate a propensity for travel, and the contextual data for the location of the advertising medium 116 may include a weather forecast of snow for the next week. As such, the advertising engine 120 may identify advertising content, at the data structure 122, relating to travel to a warm location and cause the content to display at the advertising medium 116. In addition, in various embodiments, the advertising engine 120 may use prior interactions with the advertising medium 116 as a basis (at least in part) for selecting advertising content. For instance, in the above example, different advertising content may be available for selection by the advertising engine 120 relating to travel to a warm location, with one directed toward Arizona and one directed toward Florida. If consumers routinely interact with the advertising content for Arizona, but not the one for Florida, the advertising engine 120 may take into account such prior interaction and select the advertising content for Arizona,

Once the advertising content is selected, the advertising engine 120 transmits the advertising content to the advertising medium 116, at 324, in a format consistent with the advertising medium 116 (e.g., consistent with a size and/or a resolution of the advertising medium 116, etc.). The advertising content, as transmitted, may be complete and/or may be in one or more formats and/or parts. Alternatively, the advertising engine 120 may transmit to the advertising medium 116 (e.g., at 324, etc.) an identity of the consumer 112 (e.g. a name, etc.) and also an identifier of a particular offer, from which the advertising medium 116 retrieves the offer, based on the offer identifier, from the data structure 122 (or another data structure). Here, the advertising medium 116 then compiles the advertising content to be displayed at the advertising medium 116 by incorporating the consumer's identity into the retrieved offer (such that the advertising content is specific to the consumer 112).

At 326, the advertising engine 120 then causes the advertising content to display at the advertising medium 116, for viewing by the consumer 112. In response, the consumer 112 may decide to take advantage of the offer, discount, sale, etc., or not. For example, the advertising content/offer may include a QR code that can be scanned and/or otherwise detected by the consumer's communication device 114, for completion of the sale at the communication device 114 and/or for further presentation of the offer, discount, sale, etc. at the corresponding merchant. It should be appreciated that the offer, discount, sale, etc., presented at the advertising medium 116 may be accepted in a variety of manners.

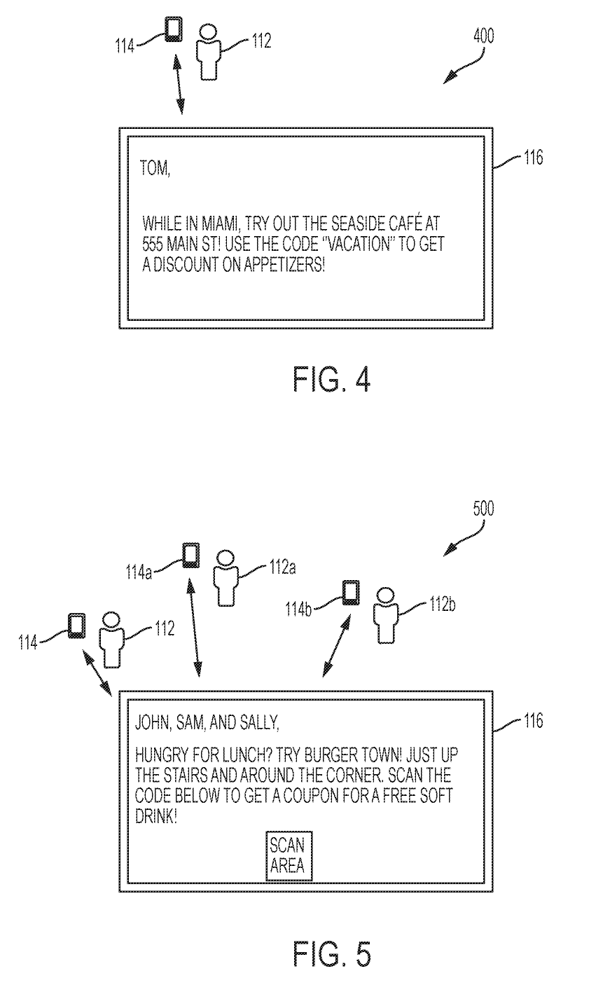

FIG. 4 illustrates an example interface 400 that may be displayed to the consumer 112 at the advertising medium 116 when the consumer's communication device 114 is in proximity thereto, for example, at an airport. In this example, as the consumer 112 passes near the advertising medium 116 (and/or, in some embodiments, the beacon 118 associated with the advertising medium 116), the advertising medium 116 detects the proximity of the consumer's communication device 114 (or vice versa). In response, one or more of the communication device 114 and the advertising medium 116 transmits a MPM to the advertising engine 120, through which the advertising engine 120 identifies the consumer 112 and the advertising medium 116. In turn, the advertising engine 120 collects the consumer profile of the consumer 112, which includes, for example, the consumer's name, gender, age, income level, education level, and address. The consumer profile of the consumer 112 also includes transaction data for the consumer 112, indicating that the consumer recently purchased airline tickets for travel to Miami, Fla., and an indication that the consumer 112 has an upscale dining propensity score. The upscale dining propensity score suggests that the consumer 112 enjoys dining at nice restaurants.

Using the consumer profile information for the consumer 112, the advertising engine 120 accesses advertising content from the data structure 122 having high relevance to upscale dining in the Miami area. In this example, the advertising engine 120 locates two possible restaurant advertisements, and selects the advertisement that has been displayed the least. The selected advertisement is sent to the advertising medium 116 for display to the consumer 112, as shown in the interface 400 of FIG. 4. The advertising medium 116 may also play an audio portion of the advertisement, such as music or a recording of the text of the advertisement. As shown in FIG. 4, the advertisement in this example includes the consumer's name (i.e., Tom), as determined from the consumer profile, and a message that invites Tom to try the Seaside Café while in Miami (such that the content is specific to Tom). The advertisement also provides a code which may be used by Tom to get a discount on appetizers, or which may be shared by Tom with others.

FIG. 5 illustrates another example interface 500 that may be displayed to multiple consumers at the advertising medium 116, when the consumers are in proximity to the advertising medium 116, for example, on a subway platform in New York City. In this example, as the consumers 112, 112a, 112b pass near the advertising medium 116, the advertising medium 116 detects the proximity of communication devices 114, 114a, 114b associated with the consumers 112, 112a, 112b (or vice versa). In response, the communication devices 114, 114a, 114b (or the advertising medium 116) transmit MPM's to the advertising engine 120, through which the advertising engine 120 identifies the consumers 112, 112a, 112b and the advertising medium 116. In turn, the advertising engine 120 collects the consumer profiles of the consumers 112, 112a, 112b. The consumer profiles, for each of the consumers 112, 112a, 112b, include indications that the consumers 112, 112a, 112b are each likely to dine at fast-food restaurants. In turn, the advertising engine 120 builds a composite or aggregate profile (as described above) based on each consumer profile. In this example, the aggregate profile may indicate that the consumers 112, 112a, 112b have a high propensity for fast food purchases. In addition, the advertising engine 120 may further determine the current time of day and location of the consumers 112, 112a, 112b (and advertising medium 116).

Using the aggregate profile for the consumers 112, 112a, 112b, the advertising engine 120 accesses advertising content from the data structure 122 matching the aggregate profile. In this example, the advertising engine 120 may find four advertisements that match the aggregate profile. Further, the advertising engine 120 may determine, based on transaction histories of the consumers 112, 112a, 112b, that one of the four advertisements is for Burger Town, which is a fast food restaurant that the three consumers 112, 112a, 112b have not recently patronized. As such, the advertising engine 120 provides the Burger Town advertisement to the advertising medium 116 along with the names of the three consumers 112, 112a, 112b, as shown in the interface 500 of FIG. 5. As shown in FIG. 5, the advertisement in this example includes the names of the three consumers 112, 112a, 112b (i.e., John, Sam, and Sally) as well as a suggestion to try Burger Town. The advertisement also includes directions to Burger Town from the subway platform (i.e., up the stairs and around the corner), and a scan area that may be scanned by the consumers using their communication devices in order to get a coupon for a free soft drink (and/or share the coupon with others, as allowed by the advertisement). The advertisement may also include audio in the form of music, speaking, or the like, and video/animation.

While the interface 500 includes a single advertisement directed, jointly (or in aggregate), to three different consumers (i.e., to John, Sam, and Sally), in other embodiments interfaces may be split into two or more displays or viewing regions (based on available viewable area of the applicable advertising medium) where each display or viewing region includes an advertising content particular to a particular consumer (or group of consumers) proximate to the advertising medium. The particular division of the consumers to the different displays or viewing regions may be based on timing of receipt of MPMs by the advertising engine 120, on relationships between the consumers, etc. As an example, and without limitation, the interface 500 may be divided in half, horizontally, with a left display including advertising content for John and Sam (based on MPMs associated with John and Sally being received within a first interval), and then a right display including advertising content for Sally (based on an MPM associated with Sally being received after the first interval).

It should be understood that the interfaces 400, 500 described with respect to FIGS. 4 and 5 are exemplary in nature and are not limiting. Other iterations of the described system 100 and/or method 300 may be implemented with some, all, or none of the details described in these examples.

In view of the above, the methods and systems herein may permit advertising media to be utilized in an efficient and interactive manner to deliver advertising content, which is specific to the consumer and/or consumers in proximity to the advertising media. In this manner, the advertising content may include an improved probability that the consumer(s) will view, access and/or redeem the offers, discounts, sales, etc. associated with the advertising content.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) receiving a media proximity message (MPM) associated with an advertising medium, the MPM including an advertising medium identifier and a consumer identifier for a consumer in proximity to the advertising medium; (b) accessing location context for the advertising medium from an advertising media data structure, based on the advertising medium identifier; (c) accessing a consumer profile for the consumer from a consumer profiles data structure, based on the consumer identifier; (d) selecting an advertising content, from an advertising content data structure, based on at least the consumer profile and the location context; (e) causing the selected advertising content to be displayed at the advertising medium, whereby the advertising medium is generally provisioned (e.g., linked or tuned, etc.) to the consumer in proximity to the advertising medium and the advertising content is associated with (e.g., specific to or generally personal to, etc.) the consumer; (f) receiving a subsequent MPM associated with said advertising medium, the subsequent MPM including a subsequent consumer identifier for another consumer; and (g) generating an aggregate profile based on the consumer profile for the consumer and a consumer profile for the another consumer.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” “coupled to,” or “in communication with” another element, it may be directly on, connected or coupled to, or in communication with the other element, or intervening elements may be present. In contrast, when an element is referred to as being “directly on,” “directly connected to,” “directly coupled to,” or “directly in communication with” another element, there may be no intervening elements present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the example embodiments.

What is claimed is:

1. A computer-implemented method for use in providing advertising content at an advertising medium, the method comprising:
receiving, by a computing device, a media proximity message (MPM) associated with an advertising medium, the MPM including an advertising medium identifier and a consumer identifier for a consumer in proximity to the advertising medium;
accessing, by the computing device, location context for the advertising medium from an advertising media data structure, based on the advertising medium identifier;
accessing, by the computing device, a consumer profile for the consumer from a consumer profiles data structure, based on the consumer identifier;
selecting, by the computing device, an advertising content, from an advertising content data structure, based on at least the consumer profile and the location context; and
causing the selected advertising content to be displayed at the advertising medium, whereby the advertising medium is generally provisioned to the consumer in proximity to the advertising medium and the advertising content is associated with the consumer.

2. The computer-implemented method of claim 1, wherein receiving the MPM includes receiving the MPM from a communication device associated with the consumer; and
wherein causing the selected advertising content to be displayed at the advertising medium includes transmitting the selected advertising content to the advertising medium.

3. The computer-implemented method of claim 2, wherein the consumer profile includes at least one parameter based on transaction data for the consumer.

4. The computer-implemented method of claim 1, further comprising:
receiving a subsequent MPM associated with said advertising medium, the subsequent MPM including a subsequent consumer identifier for another consumer; and
generating an aggregate profile based on the consumer profile for the consumer and a consumer profile for the another consumer;
wherein selecting the advertising content includes selecting the advertising content based on at least the aggregate consumer profile and the location context.

5. The computer-implemented method of claim 4, wherein generating the aggregate profile includes identifying at least one feature common to the consumer profile for the consumer and the consumer profile for the another consumer.

6. The computer-implemented method of claim 4, wherein selecting the advertising content includes selecting the advertising content after a predefined interval; and
wherein receiving the MPM and the subsequent MPM includes receiving the MPM and the subsequent MPM during the predefined interval.

7. The computer-implemented method of claim 1, wherein the location context includes at least one of a time of day, a day of week, and a weather condition at a location of the advertising medium.

8. The computer-implemented method of claim 1, wherein the advertising content includes at least one of a coupon and a discount for a product.

9. The computer-implemented method of claim 1, wherein causing the selected advertising content to be displayed includes causing the selected advertising content to be displayed for a predefined interval, regardless of receiving a subsequent MPM associated with a different consumer.

10. The computer-implemented method of claim 1, wherein receiving the MPM includes receiving the MPM from the advertising medium.

11. A system for use in providing advertising content to consumers, the system comprising:
a memory including advertising content relating to multiple different products and multiple different merchants, and consumer profiles for multiple consumers; and
a processor in communication with the memory, the processor configured to:
retrieve a consumer profile from the memory for a consumer in proximity to an advertising medium at which advertising content is to be displayed;
retrieve location context data for the advertising medium;
select an advertising content from the memory, based on at least the consumer profile for the consumer and the location context data for the advertising medium; and
cause the selected advertising content to be displayed at the advertising medium, whereby the advertising medium is generally provisioned to the consumer in proximity to the advertising medium and the advertising content is associated with the consumer.

12. The system of claim 11, wherein the processor is configured to:
retrieve a consumer profile from the memory for each of one or more additional consumers in proximity to the advertising medium;
select additional advertising content from the memory, based on at least the consumer profile for each of the one or more additional consumers and the location context data for the advertising medium; and
cause the selected additional advertising content to be displayed at the advertising medium, whereby the advertising medium is generally further provisioned to the one or more additional consumers in proximity to the advertising medium and the additional advertising content is associated with the one or more additional consumers.

13. The system of claim 11, wherein the consumer profile includes at least one spending propensity model for the consumer based on transaction data for the consumer.

14. The system of claim 13, further comprising a payment network configured to generate the at least one spending propensity model for the consumer, based on the transaction data for the consumer;
wherein the processor is configured to access the at least one spending propensity model for the consumer and associate the at least one spending propensity model with the consumer profile for the consumer.

15. The system of claim 11, wherein, in connection with retrieving a consumer profile from the memory for the consumer in proximity to the advertising medium, the processor is configured to retrieve a consumer profile from the memory for multiple different consumers in proximity to the advertising medium.

16. The system of claim 15, wherein the processor is configured to generate an aggregate profile based on the retrieved consumer profiles for the multiple different consumers; and
wherein, in connection with selecting the advertising content from the memory, the processor is configured to select the advertising content based on at least the aggregate profile for the multiple different consumers and the location context data for the advertising medium.

17. The system of claim 11, further comprising the advertising medium;
wherein the advertising medium is configured to transmit a media proximity message (MPM) to the processor including an identifier for the advertising medium and/or an identifier for the consumer.

18. The system of claim 11, further comprising non-transitory computer readable storage media including computer executable instructions for use in a communication device that, when executed by the communication device, cause the communication device to detect the advertising medium and transmit a media proximity message (MPM) to the processor including an identifier for the advertising medium and/or an identifier for the consumer.

19. A non-transitory computer readable storage media including executable instructions for use in providing advertising content to advertising media that, when executed by at least one processor, cause the at least one processor to:
receive a media proximity message (MPM) associated with an advertising medium for each of one or multiple consumers in proximity to the advertising medium, each MPM received from at least one of a communication device associated with a consumer in proximity to the advertising medium, and each MPM including an identifier for the advertising medium and an identifier for the associated consumer;
access location context data for the advertising medium, based on the identifier for the advertising medium, from an advertising media data structure;
for each received MPM, access a consumer profile for the associated consumer, based on the consumer identifier included in the MPM, from a consumer profiles data structure;
in response to one received MPM, select an advertising content, from an advertising content data structure, based on the consumer profile for the associated consumer and the location context data;
in response to multiple received MPMs, select an advertising content, from the advertising content data structure, based on at least one of the consumer profiles for the associated consumers and on the location context data; and
cause the selected advertising content to be displayed at the advertising medium, whereby the advertising medium is generally provisioned to the consumer(s) in proximity to the advertising medium and the advertising content is associated with the consumer(s).

20. The non-transitory computer readable storage media of claim 19, wherein, in connection with selecting the advertising content in response to multiple received MPMs, the at least one processor is configured to:
select said advertising content when the multiple MPMs are received within a predefined interval; and
base said selected advertising content on multiple ones of the consumer profiles for the consumers associated with the multiple received MPMs.
